(19) United States
(12) Patent Application Publication
(10) Pub. No.: US 2011/0129640 A1
(43) Pub. Date: Jun. 2, 2011

(54) METHOD AND BINDER FOR POROUS ARTICLES

(76) Inventors: George Halsey Beall, Big Flats, NY (US); Michael Thomas Gallagher, Corning, NY (US); Keith Leonard House, Corning, NY (US); Sriram Rangarajan Iyer, Painted Post, NY (US); Paul John Shustack, Elmira, NY (US)

(21) Appl. No.: 12/627,216

(22) Filed: Nov. 30, 2009

(51) Int. Cl. B32B 3/12; B29C 44/24; B32B 18/00; C03C 6/00; C04B 35/195

(52) U.S. Cl. 428/116; 264/45.1; 428/119; 501/27; 501/153

(57) ABSTRACT

A method for making porous articles, including: depositing a powder mixture layer comprising a binder powder, and at least one structural powder; contacting the powder mixture layer and an aqueous liquid to selectively activate the binder powder and form a green layer; repeating the depositing and the contacting sequence at least one time; and de-powdering and drying of the resulting green body. The binder powder can include, for example, a protein that is soluble in water at or below about 25° C. The disclosure also provides articles, having high porosity and optionally intricate 3D structures, as defined herein.

The entire disclosure of any publication, patent, or patent document mentioned herein is incorporated by reference.

### FIELD

The disclosure relates generally to methods of making porous three dimensional (3D) ceramic articles, using 3D powder printing.

### SUMMARY

The disclosure provides a method of making high porosity articles by 3D printing. The disclosure also provides high porosity aluminosilicate materials, and like materials, and methods for their manufacture.

### BRIEF DESCRIPTION OF THE DRAWING(S)

In embodiments of the disclosure:

FIG. 1 shows exemplary photographic images of fused cordierite bodies that can be made according to the disclosed process.

FIG. 2 is a graph of the material green strength as a function of the fish gelatin (FG) content in wt. %.

FIG. 3 is a flow chart summarizing aspects of the disclosed preparative process.

FIG. 4 shows exemplary porosity of a 3D printed structure at different stages of the process: A. printed; B. green impregnated; C. Brown or partially fired; and C. fired.

FIG. 5 shows a comparison fired material strength (F.M.S.) and the percent fired porosity (F.P.) for cast (molded) articles and 3D printed articles.

FIGS. 6A, 6B, and 6C show the influence of peak firing temperature (P.F.T. (° C.)) on the apparent porosity after being fired (F. P.) or the bar apparent porosity after fire (B.A.P.) of selected materials: (A) cordierite, (B) mullite, and (C) b-spodumene, respectively.

FIG. 7 shows a photo image of a lattice structure similar to a sample used for testing water flow.

FIG. 8 shows a graduated porous structure that equalizes the flow front and provides better catalyst utilization.

### DETAILED DESCRIPTION

Various embodiments of the disclosure will be described in detail with reference to drawings, if any. Reference to various embodiments does not limit the scope of the invention. Additionally, any examples set forth in this specification are not limiting and merely set forth some of the many possible embodiments for the claimed invention.

In embodiments of the disclosure, the issue of preparing highly porous 3D green body articles and highly porous 3D ceramic articles therefrom, or other like dispositions of the articles, and like substances, can be overcome by, for example, providing a particulate or powdered gel-former material that, along with conventional ceramic green body precursors (i.e., structural powder(s)), can be selectively activated, i.e., converted into a gel substance having adhesive or binder properties, upon contact with an aqueous liquid at or below about 25° C.

We discovered that fish gelatin protein could be used as a particulate binder that could be activated in-situ along with other particulate materials by various selective means, such as aqueous ink-jet spraying.

In embodiments, the preparative processes can use simple raw materials; for example, three components such as a previously fired powder (although batch materials or combination of batch and fired can also be used, including unfired materials); an optional sintering aid; and a binder. In embodiments, no poreformer is added to achieve porosities up to about 50 and up to about 60%. In embodiments, a poreformer can be added to further increase porosity. In embodiments, forming target shapes can be accomplished by, for example: directly by a 3D printing method, indirectly by a casting or mold method, or like methods and combinations thereof. Post processing can include, for example, oven drying and curing, solution coating, or impregnation by, for example, dipping, followed by sintering (firing at high temperature). The disclosed process can produce materials that have a total porosity. In embodiments, certain complex 3D structures that can be formed by the disclosed methods cannot be obtained by conventional extrusion methods because of the presence of non-linear structural features.

### DEFINITIONS

“Impregnation,” “impregnate,” and like terms refer to imbibing the incipient 3D piece, that is on a layer-by-layer basis, with a sol-gel precursor solution, mixture, or suspension, by for example, dip coating, ink-jetting, or like methods.

“Mesh” and like terms refer to a measure of particle size as determined by screening methods, for example, a 200 mesh screened fraction includes particles that are less than or equal to about 74 microns, and 500 mesh screened fraction includes particles that are less than or equal to about 25 microns.

“Binder powder,” and like terms refer to any material having adhesive or binding properties suitable for a structural powder and having a water solubility property at or below about 25° C., for example, a proteinaceous or like material or mixtures thereof, which is soluble in water at or below about 25° C. at a concentration of from about 0.1 to about 30 weight percent binder powder in water.

“Structural powder” and like terms refer to the ingredient(s) of the green body or ceramic composition less the binder and the pore former ingredients, that is, the residual materials that remain after firing the green body that provide shape and strength to the 3D object. Thus, for example, certain structural powders, such as sulfur or metal oxide materials, may undergo oxidation during firing and may differ from the initially charged structural powder(s).

“Include,” “includes,” or like terms means encompassing but not limited to, that is, inclusive and not exclusive.

“About” modifying, for example, the quantity of an ingredient in a composition, concentrations, volumes, process temperature, process time, yields, flow rates, pressures, and like values, and ranges thereof, employed in describing the embodiments of the disclosure, refers to variation in the numerical quantity that can occur, for example: through typical measuring and handling procedures used for making compounds, compositions, composites, concentrates or use formulations; through inadvertent error in these procedures; through differences in the manufacture, source, or purity of starting materials or ingredients used to carry out the methods; and like considerations. The term “about” also encompasses amounts that differ due to aging of a composition or formulation with a particular initial concentration or mixture, and amounts that differ due to mixing or processing a composition or formulation with a particular initial concentration or mixture. The claims appended hereto include equivalents of these “about” quantities.

“Consisting essentially of” in embodiments refers, for example, to a membrane polymer composition, to a method of making or using the membrane polymer, formulation, or composition, and articles, devices, or any apparatus of the disclosure, and can include the components or steps listed in the claim, plus other components or steps that do not materially affect the basic and novel properties of the compositions, articles, apparatus, or methods of making and use of the disclosure, such as particular reactants, particular additives or ingredients, a particular agents, a particular surface modifier or condition, or like structure, material, or process variable selected. Items that may materially affect the basic properties of the components or steps of the disclosure or that may impart undesirable characteristics to aspects of the disclosure include, for example, fish gel protein denaturation, or like functional disruption or changes to the protein's molecular structure or characteristics by chemical or physical means that may render the fish gel inoperative as a binder.

The indefinite article “a” or “an” and its corresponding definite article “the” as used herein means at least one, or one or more, unless specified otherwise.

Abbreviations, which are well known to one of ordinary skill in the art, may be used (e.g., “h” or “hr” for hour or hours, “g” or “gm” for gram(s), “mL” for milliliters, and “rt” for room temperature, “nm” for nanometers, and like abbreviations).

Specific and preferred values disclosed for components, ingredients, additives, reactants, reagents, polymers, oligomers, monomers, times, temperatures, and like aspects, and ranges thereof, are for illustration only; they do not exclude other defined values or other values within defined ranges. The compositions and methods of the disclosure include those having any value or any combination of the values, specific values, more specific values, and preferred values described herein.

In embodiments, the disclosure provides porous 3D articles and methods for making the porous 3D articles.

In embodiments, the disclosure provides a 3D article or 3D green body article prepared by the disclosed preparative method.

In embodiments, the disclosure provides a method for making porous a 3D green body article, the method comprising:

depositing a powder mixture layer comprising a binder powder, and at least one structural powder;

contacting the powder mixture layer and an aqueous liquid to selectively activate the binder powder and form a green layer, for example, at least one printing of the powder mixture layer with an aqueous liquid to selectively activate the binder powder and form a green layer;

repeating the depositing and contacting at least one time, such as from about 2 to about 1,000,000 times or more, to form a 3D green body article; and

de-powdering and drying of the resulting green body.

The binder powder can comprise a protein, the protein being soluble in water at or below about 25° C., at or below about 20° C., at or below about 15° C., at or below about 10° C., and at or below about 5° C., including intermediate values and ranges.

In embodiments, the depositing a powder mixture layer and printing of the powder layer with an aqueous liquid to selectively activate the binder powder and form a green layer can be sequentially repeated two or more times to build-up and define a article having a pre-determined three-dimensional structure.

In embodiments, the protein, soluble in water at or below about 25° C., can be, for example, milk protein, soybean protein, peanut protein, wheat protein, egg protein, fish gelatin, ferritin, a protein hydrozylate, and like materials, or combinations thereof. In embodiments, the protein, soluble in water at or below about 25° C., can be, for example, a protein hydrozylate. In embodiments, the protein, soluble in water at or below about 25° C., can be, for example, a fish gelatin.

In embodiments, the disclosure provides method for making a porous green body, the method comprising:

depositing a powder mixture layer comprising fish gelatin binder powder, and at least one structural powder;

contacting the powder mixture layer and an aqueous liquid to selectively activate the binder powder and form a green layer;

repeating the depositing and contacting at least one time, such as from about 2 to about 1,000,000 times or more, to form a 3D green body; and

depowdering and drying the resulting green body.

The fish gelatin binder powder can have, for example, an average particle size of from about 25 microns to about 74 microns (i.e., about 200 to about 500 mesh) and can be, for example, present in an amount of from about 1 to about 20 weight percent, and the at least one structural powder comprises a mixture of fine cordierite having an average particle size of less than about 15 microns and in an amount of from about 10 to about 80 weight percent, and a less-fine cordierite having an average particle size of from about 25 microns to about 74 microns (about 200 to about 500 mesh) and in an amount of from about 10 to about 80 weight percent of the total weight percent of the powder mixture.

The printing can be, for example, a 3D printer executing a CAD file with a printer control system to first, deposit a layer of the powder mixture having a thickness of from about 20 to about 200 micrometers, and second, selectively activating the fish gelatin binder in the deposited powder mixture with an aqueous spray to form a green body layer. The sequence of forming a green layer by first, depositing a layer of the powder mixture, and second, selectively activating the binder can be, after partial intermediate drying or with no partial intermediate drying, repeated many times, such as from several hundred to several million times, to form a 3D green body.

In embodiments, the at least one printing of the powder mixture layer with an aqueous liquid can be, for example, an intermediate or partial drying after each printing comprising standing for from about 0.1 to about 24 hrs at ambient temperature, and the final drying comprising heating at about 50 to 100° C. for about 1 to about 10 hrs. The at least one printing of the powder mixture layer with an aqueous liquid can be, for example, accomplished with an ink-jet printer. The method can further include a second de-powdering of the finally dried green body. The steps of depositing and the at least one printing of the powder mixture layer with an aqueous liquid can be, for example, sequentially accomplished from 2 to about 1,000,000 times.

In embodiments, the disclosed method can further include, for example, firing the resulting green body to obtain a ceramic body having a material porosity (i.e., the porosity excluding void volume obtained as a result of non-printing or null printing) of from about 50 to about 85% by void volume. The material porosity comprises microporosity which is porosity within the material of the fired ceramic body at levels of from about 50 to about 85% void volume which can arise from the less than about 100% dense packing of particles in the 3D printing process. The material porosity also comprises microporosity which is porosity within the material of the fired ceramic body which can arise from fugitive material at levels of 0 to about 40 volume % in the green bodies. This fugitive material can be a particulate material that can be blended with the powder mix used in the 3D printing, and it is a material that disappears, by for example decomposition or vaporization, upon firing to provide additional porosity of 0 to about 20%. Additionally, the porosity can comprise microporosity that is burned out upon firing and which also arises from voids between the powder particles that occur naturally in the 3D printing process. The microporosity in green body parts that come out of the 3D printing can be, for example, from 50% to 85% void volume. Additionally, another contributor to the total porosity of the disclosed articles can include macro-porosity, which is void in an amount of from about 0 to about 99% void volume arising from null 3D printing, i.e., imprinted, undeveloped, or unactivated areas in accordance with the design of the 3D article.

In embodiments, the disclosure provides a batch composition comprising a powder mixture including, for example, a fish gelatin binder, and at least one structural powder. The composition can further include water in an amount of from about 0.01 to about 10 weight percent based on the total weight of the composition.

In embodiments, the composition of the at least one structural powder can include, for example, at least one of carbon, sulfur, cordierite, beta-spodumene, zeolite, petalite, mullite, clay, alumina, silica, zirconia, soda-lime glass, borosilicate glass, silicon carbide, and like materials, or mixtures or combinations thereof.

Other suitable structural powders can include, for example, standard oxide precursors and carbonate precursors, such as sand, alumina and MgO (periclase) mixtures to produce cordierite in situ, or sand, alumina, and Li-carbonate mixtures to produce beta-spodumene.

In embodiments, the disclosure provides a porous alumino-silicate ceramic article prepared by the process, including for example:

a depositing of a powder layer comprising a mixture of a binder powder and at least one alumino-silicate source powder;

a selective contacting of the powder layer and an aqueous liquid to selectively activate the binder powder and form a green layer;

de-powdering and drying of the resulting green body; and

firing the resulting green body to afford the porous alumino-silicate ceramic article.

The depositing and the contacting can be repeated at least one time, or as many times as necessary, to form a particular 3D green body.

In embodiments, the disclosure provides a porous alumino-silicate ceramic prepared by the process, including for example: forming a green body from at least one alumino-silicate source powder;

impregnating the green body with a sol-gel precursor solution;

drying the impregnated green body to form a sol-gel on at least the interior of the green body;

optionally repeating the impregnation and drying one or more times; and

firing the green body to afford the porous alumino-silicate ceramic.

In embodiments, the disclosure provides a 3D article having a high internal geometric surface area or material porosity of from about 100 to about 2,000 square meters per cubic meter of volume of the 3D article and a substantially uniform fluid flow front therethrough. The geometric surface area is the area excluding the microporosity.

The disclosure provides a method to produce high porosity materials, such as alumino-silicate and like materials, which can be accomplished without poreformers. For example, high porosity materials and structures having porosity of about 50% to about 70% or more by volume can have particularly useful properties and have become an area interest for various applications. Higher porosity materials can be used for automotive and diesel particulate filter (DPF) applications. An improved strain tolerance has been demonstrated in non-microcracked cordierite (NMC) cordierite material (See G. Merkel, Non-Microcracked Cordierite (NMC), U.S. Pat. Pub. 2009/0137382). An improved strain tolerance translates into a higher thermal shock parameter (TSP) and may provide improved thermal shock performance.

High porosity can be created by using, for example, a fugitive poreformer that leaves behind a relic pore. However, large amounts of poreformer may be needed in conventional methods to attain 55% or 60% porosity. In some cordierite compositions, the amount of graphite pore former needed to achieve this porosity level has been estimated to be, for example, about 30% to about 50% by weight of the green body. The large quantity of pore former can cause other processing and firing issues, such as increased cost.

High porosity articles can be exploited in DPF applications and in other application areas such as increased throughput in liquid filtration, high surface area structures for catalysis, fast light-off substrates, and like applications. In embodiments, the disclosure provides methods for making a wide range of high porosity aluminosilicate materials and demonstrates the usefulness of the resulting materials in existing and new applications.

In embodiments, the disclosed method for producing high porosity materials can have, for example, at least one or more of the following features:

little or no poreformer content;

compatibility with fired, batch raw materials, or both; which can facilitate recycling of fired or unfired waste materials from existing manufacturing processes;

mechanical and other material properties unattainable by other methods including, for example, high porosity, high strain tolerance, permeability, low thermal mass, high surface area, or like properties;

3D structures can be formed having complex detail, low distortion, and useful structural attributes.

Gelatin is an example of a hydrated water soluble protein powder suitable for the disclosed fabrication method. Gelatin can be obtained by the thermal denaturation of collagen. The collagen can be extracted from animal skin or bones. Typically, the gelatin can be derived from the collagen via an acid (type A), or alkaline (type B), process. In embodiments, one suitable gelatin binder is fish gelatin (FG). Fish gelatin can be extracted from the skin of deep, cold-water fish like cod, haddock, pollock, hake, and cusk. Fish gelatin provides characteristic amino acid content. Although all gelatins are composed of the same 20 amino acids, there can be a variation in the proline and hydroxyproline amino acid content. With lower amounts of proline, there is less hydrogen bonding of gelatin in water solutions, and hence a reduction in the gelling temperature. Gelatin from cold, deep-water fish gels at about 8 to about 10° C. compared to calf skin gelatin which gels at about 30 to about 35° C.

Proteins and more specifically, gelatin can be used as a binder for ceramics (Li. Vandeperre, et al., “Gelatin gel-casting of ceramic components,” Journal of Materials Processing Technology, 2002, Vol. 135, pgs. 312-316; Y. Chen, et al., “Alumina casting based on gelation of gelatine,” Journal of the European Ceramic Society, 1998, Vol. 19, pgs. 271-275; 0. Lyckfeldt, et al., “Protein forming—a novel shaping technique for ceramics,” Journal of The European Ceramic Society, 2000, Vol. 20, pgs. 2551-2559; E. Vanswijgenhoven, et al., “Gelcasting using natural gelformers,” Ceramic Processing Science VI, 2000, pgs. 453-458; U.S. Pat. No. 6,986,810, M. Behi, “Aqueous Binder Formulation for Metal and Ceramic Feedstock for Injection Molding”; U.S. Pat. No. 4,784,812, K. Saitoh, et al., “Ceramics Binder and Production of Ceramic Articles”; Y. M. Mosin, et al., “Temporary Industrial Binders for Molding of Industrial Ceramics,” Glass and Ceramics, July 1995, Vol. 51 Nos. 7-8, pgs. 249-254). Gelatin is a water soluble polymer that can be used as a possible adhesive or filler element for 3D powder printing (see U.S. Pat. No. 5,902,441, “Method of Three Dimensional Printing”, and U.S. Pat. No. 6,416,850, “Three Dimensional Printing Materials System”). We have found that fish gelatin is particularly well suited for the application and method disclosed herein.

U.S. Pat. No. 6,770,294 and U.S. Pat. No. 7,008,639 mention fish gelatin compositions containing a hydrocolloid setting system, and U.S. Pat. No. 6,306,594 mentions fish gelatin for use in methods for micro-dispensing patterned layers for biosensors. None of these patents mentions ceramic applications.

In embodiments, the disclosure provides for the use of a particulate (powder) fish gelatin (FG) protein as a binding agent (binder) to form a complex shaped article from ceramic particles or fibers that can be, if desired, fired to yield a porous ceramic article. The particulate FG is of particular value in that it: bonds very strongly with structural powders such as precursor or actual ceramic materials; FG forms a composite body of high strength; FG bonding is easily effected (wet with water then dry); FG bonding is readily reversed by re-wetting with water; FG is non-toxic; FG can be repeatedly wetted and dried and, in embodiments, can be heated to as high as 70° C. without significant loss of its bonding properties (facilitating, for example, for high material utilization via recycling the ceramic/binder powder mix); FG is compatible with impregnation and drying treatment methods; and FG decomposes when heated in air to temperatures greater than about 400° C.

In embodiments, the 3D powder printing includes mixing an suitable organic binder, in powder form, with a ceramic, a glass, a glass-ceramic, a plastic having high thermal stability, or like powders. The combined powder mixture can be applied, such as deposited or spread or like means, into a thin layer (e.g., about 20 to about 200 microns) on a surface. Then, an aqueous liquid can be selectively applied by, for example, ink-jet sprayed onto the powder layer in a specific, computer-controlled pattern, or like applications. The liquid treated area can then be dried, or not dried. There may be little or no significant drying in between the printing of adjacent layers in instances where the liquid is rapidly absorbed into the powder layer such that it does not impact, for example, the spreading of the successive powder layer. Additional layers of the combined powder mixture can be similarly sequentially applied along an out-of-plane or z-axis and subsequently activated by ink-jet spray of the aqueous solution. The binder is selectively activated by the spray during the ink-jet deposition such that upon drying the binder bonds the ceramic, glass, glass ceramic, carbon, or like structural powders together, to form a three-dimensional article. After the 3D printing is completed, from 1 to about 48 hrs time is allowed for the partial drying of the 3D article before it is removed from the print bed. The resulting three dimensional article can be readily separated from residual un-bound powder in the non-sprayed areas by de-powdering. De-powdering can be accomplished by any suitable method, such as by vibrating, shaking, tapping, vacuuming, and like operations, or a combination thereof. The resulting three-dimensional article is a green body that can be further processed as desired, for example, dried, fired as-is, or can be impregnated with other ceramic-forming precursors, and then fired.

### Water Soluble Protein Binders

Suitable organic binders include, for example, any protein powder that is soluble in water at or below about 25° C. The protein binders can be naturally occurring, synthetic, or semi-synthetic (i.e., a natural product which is further modified by synthetic means). The protein binder can be obtained from natural sources, for example, by extraction with water from any protein source and then dried to a solid, and if necessary pulverized to a powder. A protein can also be hydrolyzed or otherwise reacted or chemically modified to render it soluble in water. Examples of water soluble proteins include, for example, milk protein, peanut protein, wheat protein, egg protein, ferritin, water soluble proteins from animal flesh such as from fowl, livestock such as cattle, horses, and sheep, and fish such as tuna. Water soluble partial hydrozylates of water insoluble proteins of the above mentioned materials can also be used, such as the collagen hydrozylates. The highly soluble proteins described in U.S. Pat. No. 5,777,080, can also be selected. Fish gelatin is a preferred protein binder because of its availability, cost, solubility properties, and excellent activation and binding properties in the disclosed method and batch compositions.

Specific organic binders for the 3D powder printing technique used to fabricate ceramic articles are disclosed herein. Suitable organic binders for this application can be, for example, any protein powder or protein powder mixture, or like material or mixture of materials, which is (are) readily soluble or solubilized in water, or like aqueous system, at or below ambient temperatures, such as at or below about 25° C. Another useful binder, alone or in admixture with protein powder, is urea formaldehyde.

The above mentioned urea formaldehyde (UF), a synthetic gel-former, was investigated. When UF-based green body products were compared to the fish gelatin binder and the corresponding green body product made therefrom in accordance with the disclosed articles and processes, the following were noted. The FG binder based green bodies: 1) had greater green strengths, such as from about 3 to about 4 fold greater; 2) used less binder for comparable strengths, e.g., about 7% versus about 10%; and 3) were reversible or recyclable whereas the UF green bodies were essentially irreversible.

In embodiments, the disclosure provides methods for ceramic green body preparation that use fish gelatin as an organic binder. The method is particularly suited for the fabrication of three dimensional ceramic, glass, glass-ceramic, polymer, plastic, composite, or like articles, using a 3D powder printing technique. Particulate fish gelatin when activated with selective application of water, or like aqueous formulations, can bond very strongly with ceramic materials, or like particulate materials, and form a green body of relatively high strength. The bonding can occur substantially only in wetted areas and the resulting fabricated parts can be easily de-powdered with little to no halo (i.e., bonding in unintentionally wetted areas). The green bodies can then, if desired, be fired, or alternatively, impregnated with other binders and then fired.

In embodiments, fish gelatin (FG) can be used as the organic binder in the 3D powder printing technique to fabricate three dimensional articles follow. Fish gelatin bonds very strongly with the glass and ceramic particulate materials and thus can form a green composite body of high strength. High bonding strength (see for example representative material green strengths in FIG. 2) allows for the use of lower levels, such as from about 4 to about 8 weight percent of binder in the green body which can help keep material costs low, help to lower volatile release during firing, and help to increase ceramic particle-to-particle contact points within the resulting ceramic body. High bonding strength compensates for the otherwise low green strength of high porosity articles. The bonding of ceramic particles can be readily achieved by blending the fish gelatin powder and one or more ceramic powders, then spreading the powder mixture into a thin (e.g., about 20 to about 200 microns) layer. Next, the powder layer can be wetted (sprayed) with water, or like aqueous solution, from an ink-jet printer or like selective applicator in the areas desired to be bonded. Additional powder layers can be similarly repeatedly applied and wetted with spray, and optionally dried, de-powdered, or both. After all the layers have been applied and sprayed, the part can be finally dried. Bonding attributable to the fish gel binder occurs substantially only in the wetted areas. The 3D parts can be readily de-powdered as indicated above. After drying, the bonding can be readily reversed or reactivated, if desired, by re-wetting the final 3D article, intermediate products, or scrap with water. Ceramic powder and fish gelatin powder blends can be repeatedly wetted and dried, and can be heated to temperatures as high as 70° C. without significant deterioration in properties, allowing for more efficient material utilization, as the ceramic and binder powder mixture can be recycled and reused if desired. The fabricated 3D green bodies using these materials and the disclosed process are compatible with available impregnation and drying treatment processes, see for example, commonly owned and assigned copending patent application U.S. Ser. No. 12/121,223, filed May 15, 2008. This post-forming processing, including a combined impregnation and drying can be accomplished, for example, to enhance the strength of the article in firing, enhance sintering, enhance the strength of the fused body, or combinations thereof. Finally, fish gelatin is relatively low cost, non-toxic, non-polluting to the environment, and burns-off when heated in air at temperatures above about 400° C. and above.

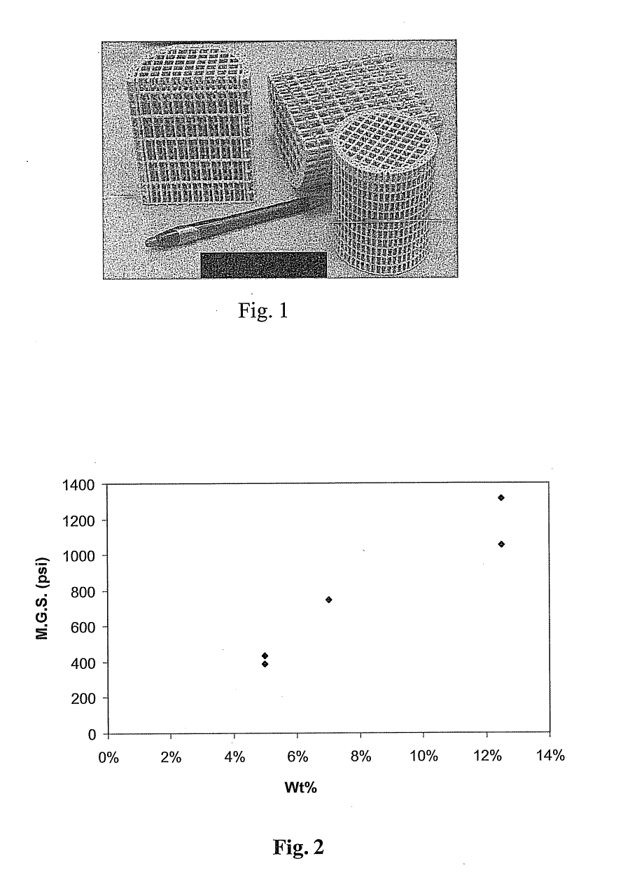

FIG. 1 provides photographic images of cordierite bodies made according to the disclosed process, i.e., lattice parts after firing. FIG. 2 is a graph of green strength as a function of the fish gelatin (FG) content in weight percent and shows excellent strengths, for example, at from about 5 wt % to about 12 wt %.

### EXAMPLES

The following examples do not limit the scope of this disclosure, but rather are illustrative. The working examples further describe how to make and use the articles and methods of the disclosure.

The starting materials, such as synthetic, semi-synthetic, naturally occurring proteins such as native proteins, and like materials, are commercially available such as from Sigma-Aldrich and like suppliers; can be, for example, prepared by known methods; and can be isolated from a complex matrix by known methods. All commercially available chemicals were used as received.

### Example 1

7 wt % particulate fish gelatin (FG) powder (200 to 500 mesh), 10 wt % fine cordierite powder (<15 microns), and 83 wt % less-fine cordierite powder (200 to 500 mesh) were used. The cordierite powder came from crushed recycled cordierite material. Alternatively virgin ingredients or a mixture of virgin and recycled ingredients can be used. Before crushing, the recycled cordierite material had about 20% porosity. A commercially available 3D printer (Z-Corporation 510z) was used to print green bodies according to the following procedure:

1. mixing the FG, fine cordierite, and less-fine cordierite powders in an approximate 7:10:83 weight percent ratio;

2. loading the combined powder mix into the 3D printer;

3. creating green body design CAD files and transferring these files onto the computer of the printer control system;

4. running the printing routine, i.e., depositing a powder mixture layer then selectively activating the binder with the selective application of the spray solution, and repeating the depositing and activating to form the green body;

5. waiting for about 2 to about 24 hrs for the partial drying of the green body;

6. removing the un-inked powder from around the green body, that is depowdering the body, using any suitable method, and manually or robotically remove the green body from the printer;

7. drying the green body into an oven at 85° C. for about 2 to about 8 hrs; and

8. optionally further de-powdering the green body as desired or as needed.

Impregnation and Drying Process. The above formed green body can be further transformed into a cordierite body as follows:

1. impregnating the green body by dipping it into a cordierite sol-precursor solution (e.g., 15 second dip) described below;

2. drying the impregnated body in an 85° C. oven to evaporate the solvent and to precipitate a sol-gel polymer between the particles within the body;

3. repeating step 1;

4. repeating step 2; and

5. firing according to 12 hrs ramp to 1,410° C., then 4 hr hold at 1,410° C., then 2 hr cool to ambient temperature.

Cordierite Sol-Precursor Solution Formulation. A sol-precursor solution can be prepared as follows:

1. stirring a mixture of 2-methoxyethanol (791.3 grams), magnesium ethoxide (62.5 grams), and aluminum butoxide (269.4 grams) on a stir plate;

2. adding tetraethylorthosilicate (TEOS) (283.7 grams) to the resulting mixture of step 1;

3. carefully blending nitric acid (90.24 grams) into ethanol (146.75 grams), then slowly adding the blended mixture to the resulting stirred solution of step 2; and

4. adding ethanol (197.25 grams) to resulting mixture of step 3, then capping the mixture and stirring for 16 hours at 50° C.

The impregnation and drying treatment is described in commonly owned and assigned copending applications U.S. Ser. No. 12/121,223. We discovered that the green bodies made with the FG protein of the present disclosure survive the sol-precursor impregnation process without issue. If the green bodies are subsequently wetted with water the FG protein dissolves and the green bodies crumble, which permits recycling and reduction in scrap.

During firing the structures are free standing. We have found that, in embodiments, some sag may occur in firing. The degree of sag can be, for example, about 0.2 to 0.5 mm for a 6.3 mm×6.3 mm×50 mm bar spanned across a 40 mm span. Linear shrinkage in firing can be, for example, about 5%. Distortion, other than sag, can be, for example, less than about 2%.

### Comparative Example 2

Example 1 was repeated with the exception that the FG protein powder was instead dissolved in the ink-jetted spray solution with the result that jetting was compromised due to gelation and the resulting parts were highly strength compromised, parts lacked structural and handling strength integrity.

### Example 3

Comparable fused bodies were prepared with several materials other than cordierite by following the disclosed process. These other materials included Vycor® glass, mullite, beta-spodumene glass, and petalite (a mineral which converts to beta-spodumene on heating). These materials were prepared in fine and less-fine powder form and were substituted for the cordierite powder mixtures in the disclosed process. Firing conditions differed in that peak firing temperatures were adjusted. Different inorganic materials sinter at different temperatures. For example, cordierite sintering temperatures are typically from about 1,400 to about 1,430° C., while mullite may be sintered at from about 1,450 to about 1,600° C. For each of the different compositions the sintering temperatures were adjusted to measure the impact on porosity. The sol-precursor solutions for the comparables differed in that the metal oxide mixture resulting from the sol-precursor matched the metal oxide mix of each of the ceramic powders.

Variations on the disclosed process can provide enhanced strength and other structural and material properties to the green body, the fired ceramic, or both, and can include, for example:

use of a sol-precursor solution that gives metal oxide ratios that do not match the ceramic powder; and

use of colloidal dispersions of ceramic materials for impregnation, coating, or both of the green bodies prior to firing.

FIG. 2 shows that excellent green strength of bodies can be obtained using FG protein in 3D printing.

The data in Table 1 was from 3D printer experiments with powder mixtures of cordierite powder and particulate FG protein. These are strength data for 6.3×6.3×100 mm bars following 2 hrs hold in the print bed and 2 hrs drying in an oven at 85° C. The printed and dried green bodies had about 60 to about 65% porosity. For de-powdering and handling in these embodiments, it was found that 700 psi strength is generally more than sufficient for handling and depowdering the part. A typical combination used for the powder mix was 7 wt % FG powder and 93 wt % cordierite powder. Other representative combinations of FG:cordierite powders include, for example, (w:w) 2:98, 3:97, 4:96, 5:95, 6:94, 7:93, 8:92, 9:91, 10:90, 11:89, 12:88, 13:87, 14:86, 15:85, and like weight ratios, including intermediate values and ranges.

TABLE 1

| | wt % | | | wt % | wt % | | | |
|---|---|---|---|---|---|---|---|---|
| | FG | wt % FG | FG | cordierite | cordierite | print | % | green |
| | 25 to 74 | 35 to 74 | total | <15 | 15 to 74 | density | green | strength |
| Run | microns | microns | wt % | microns | microns | (g/cc) | porosity | (psi) |
| 1 | 0 | 5.0 | 5.0 | 20.0 | 75.0 | 0.93 | 63 | 435 |
| 2 | 0 | 5.0 | 5.0 | 20.0 | 75.0 | 0.91 | 64 | 388 |
| 3 | 12.5 | 0.0 | 12.5 | 12.5 | 75.0 | 0.91 | 61 | 1314 |
| 4 | 0 | 12.5 | 12.5 | 12.5 | 75.0 | 0.90 | 62 | 1056 |
| 5 | 0 | 7.0 | 7.0 | 13.3 | 79.7 | 0.89 | 64 | 745 |

‘FG . . . microns’ refers to indicated particle size range in micrometers of the fish gel powder.

Using 3D printing and the FG protein powder in accordance with the disclosure, green bodies having comparable green strengths for several other materials were produced and are listed in Table 2.

TABLE 2

| | green strength |
|---|---|
| Powder Mixtures (in wt %) used in 3D Printine | (psi) |
| 80% carbon, 8% sulfur, 8% MnO₂, and 4% FG protein | 614 |
| 97% betaspodumene and 3.5% FG protein | 784 |
| 96% petalite and 4% FG protein | 546 |
| 95% mullite 5% clay and a 4% FG | 310 |
| protein superaddition | |
| 93% calcium silicate glass and 7% FG protein | 1,637 |

The green bodies of Table 3 made with the indicated alternative powder mixes had about 60 to about 65% porosity.

By processing the green bodies using the disclosed sol precursor impregnation and firing steps, the green bodies can be transformed into fused ceramic bodies. This was accomplished for several different green body combinations listed in Table 3.

TABLE 3

| | Peak Firing | material porosity | material strength | sag in firing, for |
|---|---|---|---|---|
| Powder Mixture used in 3D | Temp | after firing | after firing | 6.3 × 6.3 × 50 mm |
| Printing | (° C.) | (%) | (psi) | bar spanned 40 mm |
| 93% Cordierite and 7% FG protein | 1,410 | 60% | 1,000 | 0.2 |
| 97% betaspodumene and 3.5% FG | 1,350 | 68% | 600 | 0.3 |
| protein | | | | |
| 96% petalite and 4% FG protein | 1,350 | 65% | 1,250 | <0.5 |
| 95% mullite, 5% clay, and a 7% FG | 1,475 | 67% | 1,000 | 0.7 |
| protein superaddition | | | | |

For each of the powder mixtures in Table 3, the impregnating sol-precursor solutions were formulated to match the metal oxide ratios of the ceramic powder component used in the powder mixtures for 3D printing. The results show that high porosity fused ceramic bodies of good mechanical strength and with minimal distortion in firing can be obtained for the green bodies formed in embodiments of the disclosure using FG protein as the binder.

Aspects of the disclosure include, for example:

Materials and composition. The disclosed methods provide flexibility to create a variety of aluminosilicate materials. In contrast to extrusion, the inorganic raw materials of the disclosure can be fired materials (such as fired, ground cordierite) although batch materials can be used also.

Table 4 shows aluminosilicate materials that have been prepared using the disclosed process, including mullite, cordierite, β-spodumene, and zeolite. This process can be adapted to the whole family of aluminosilicates: β-eucryptite, nepheline, leucite, pollucite, anorthite, strontium feldspar, celsian, and β-quartz solid solutions including β-Eucryptite with a negative coefficient of thermal expansion (CTE). This method can be used as an alternative to extrusion and is equally versatile in the type of materials that can be used.

Raw materials. Table 4 also shows raw materials used for the prepared aluminosilicate materials. The ingredients of the batch are a) inorganic powder (aluminosilicate or precursor), b) binder and c) sintering aid. Poreformer can be added as necessary. Compared to a standard extrusion process which uses mainly batch components and the requisite aluminosilicate composition formed through a reaction sintering process, e.g., cordierite fanned through talc, alumina, clay, and silica, in the disclosure uses parts that can be made directly with aluminosilicate powder and traditional ceramic sintering. For example, in the present disclosure, cordierite and mullite structures were created using cordierite grog, and mullite grog, respectively. However, the process is flexible enough to use either batch or fired raw materials.

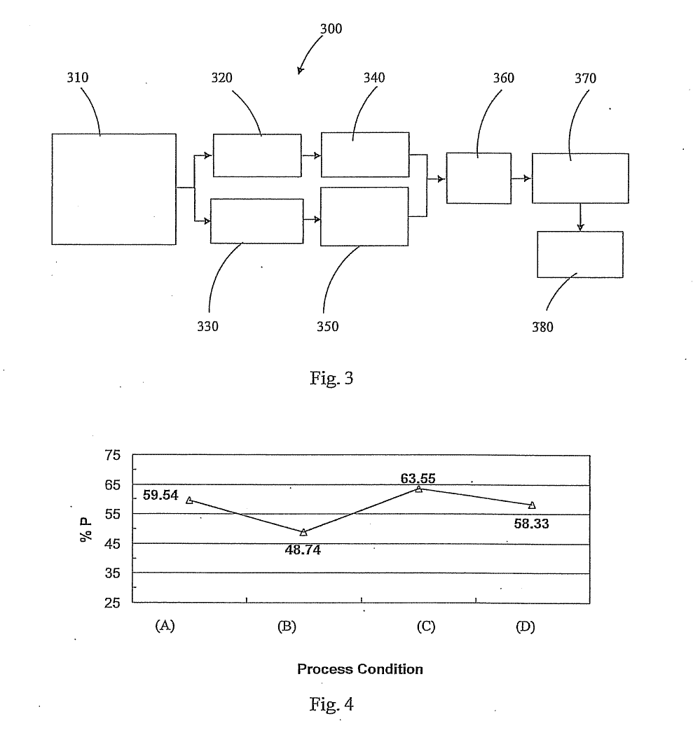

Process FIG. 3 is a flow chart that summarizes aspects of the general preparative method of the disclosure. The steps include, for example, raw materials preparation (classification) and batching; mixing and forming (casting or 3D printing); drying/curing to form green structure; impregnation with ceramic slurry or sol; and firing. 3D printing is known (see e.g., U.S. Pat. Nos. 5,205,055; 5,340,656; and 5,387,380). In embodiments, the disclosure applies 3D printing methodologies to aluminosilicates to obtain high porosity materials. Cast materials can also be made.

All other materials were made using the 3D process. FIG. 3 shows the unit processes (300) to create final structure/form. Raw material can be prepared by classifying (310) all components to about a 35 mm particle size. This can be followed by batch weighing and mixing, dry (320) or wet (330), of the raw materials. One aspect of the process is in the forming step. Forming the structure can be achieved directly by 3D printing (340) or indirectly by casting method (350). For direct forming of the structures, the mixing step can be accomplished dry. The mixed powder can be fed into the 3D printer which creates the structure by a sequence of powder layer formation and binder powder activation. “Lost wax” is a known ceramic forming process where powders are mixed with water and, if necessary, a surfactant to create a slurry of adequate viscosity. This slurry can then be cast into a mold (350). Subsequent processing can include drying/curing the slurry (360), removal from the mold, and firing into a ceramic.

The formed product (by either method) is then dried (to remove moisture), cured to a rigid green body, or both. In the sol-precursor dip step (Sol dipping/impregnation) (370), the part can be dipped into a sol-precursor solution. The sol-precursor composition can also be tailored to form the required aluminosilicate. This step adds strength to the green structure until fired. The final step of the process is firing (380). In this step, the binder is burnt out and the powder compact is sintered into a porous ceramic.

One aspect of the disclosed process is the combination of 3D printing and sol-precursor dip step. Selected 3D process data and results are tabulated below.

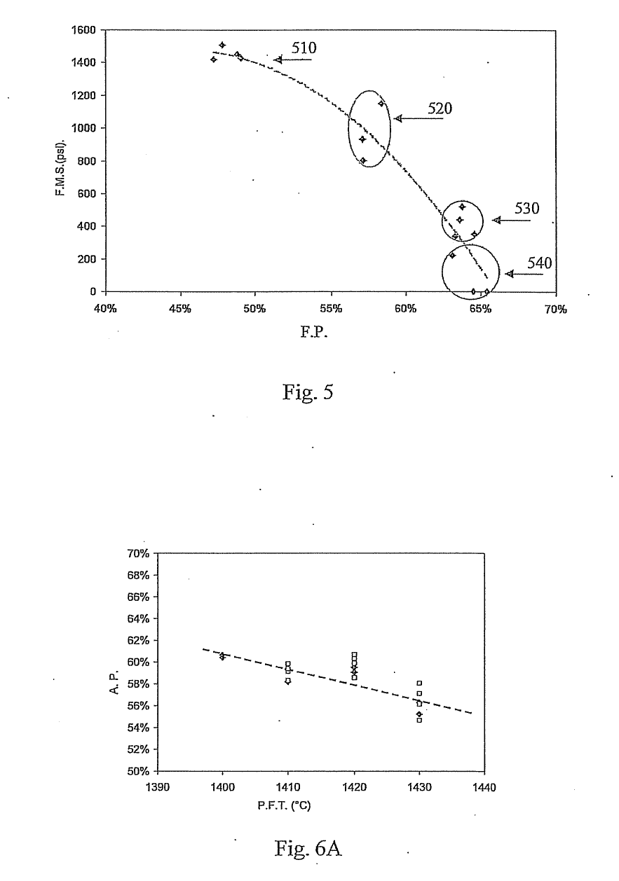

3D Printing, Casting, and Extrusion Processing. FIG. 1 shows examples of structures created according to the present disclosure via 3D printing. Very complex structures can be created using the 3D print method. Table 5 and FIG. 5 compare the 3D printing process to casting for cordierite. Porosity (apparent) of about 48 to 67% was demonstrated. For cast and 3D printed cordierite without poreformer, the porosity was about 48% to about 58%. This was about 10 to about 20% higher than extruded cordierite compositions without poreformer (e.g., about 30% to about 40%). In general, when casting is compared to 3D printing, the casting process gives lower porosity and better firing strength. The enumerated clusters in FIG. 5 are identified as follows:

formed with casting process, with either no dipping or dipping (i.e., impregnation) accomplished twice (510);

formed by the 3D printed process, with dipping accomplished 2 or 3 times (520);

formed with the casting process with 18% graphite add as poreformer with dipping accomplished twice (530);

formed with the 3D printing process with 18% graphite added as poreformer and no impregnation dipping (540).

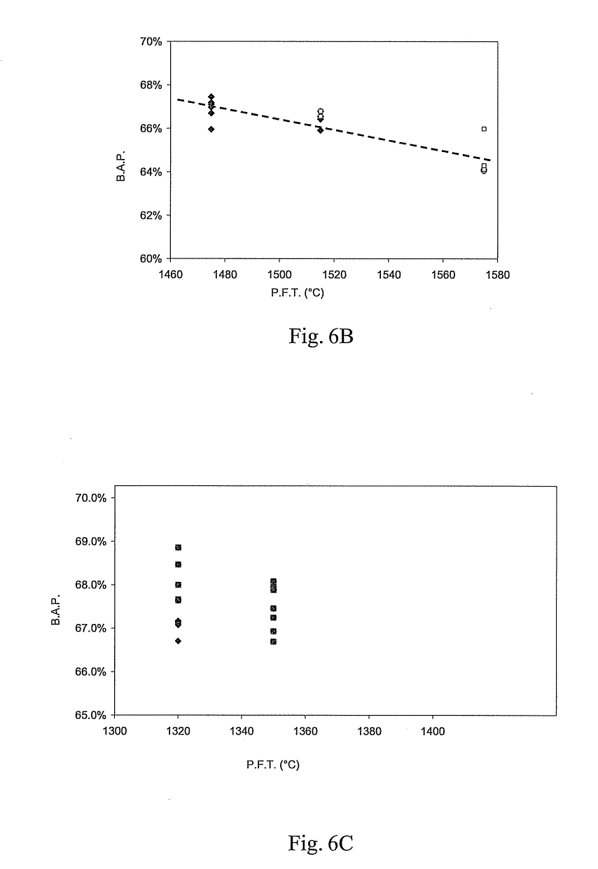

Porosity creation and control. High intrinsic porosity is generated by creating an open structure in the green state that is then maintained through the firing process. FIG. 4 shows the article porosity from green body through the firing process to the fired article. A key aspect is the choice of particle size and distribution of raw materials and firing schedule that creates a green ceramic structure with high porosity. The high porosity is retained in subsequent processing steps. Starting green porosity in this particular example (cordierite with UF binder, i.e., urea formaldehyde) was about 59%. Here, the green porosity for this process is dictated by particle size, size distribution, and shape. The 3D printing process uses about 35 micron powder (e.g., about 200 to 500 mesh) with about 10 to about 15% fines. Fines are typically less than 15 microns. Control of green porosity can be achieved through suitable modification of powder size and concentration of fines. Fired porosity can also be controlled through use of poreformer and sintering temperature. FIGS. 6A-6C, respectively, show the effect of firing temperature on porosity for three compositions: cordierite, mullite, and β-spodumene. With increased temperature further sintering in the body reduces the total porosity by up to about 4%.

Table 6 shows that there can be added up to about 6% porosity with about 20% graphite pore former addition for the 3D print process, and up to about 16% to about 18% graphite pore former addition for the casting route.

Attributes—The properties and results from the process on various aluminosilicates are shown in Tables 6 and 7. These materials show higher porosity as compared to existing materials and processes.

High strain tolerance—The elastic modulus of a body drops faster than the strength with increasing porosity beyond the 45% range. Higher porosity results in an increased strain tolerance. This property can be exploited to make low micro-cracked or non-microcracked materials suitable for, for example, diesel particulate filters, gasoline particulate filters, or catalytic filters. Table 7 compares strain tolerance and Thermal Shock Parameter for the disclosed materials with low microcracked cordierite (LMC) and non-microcracked (NMC) cordierite. Strain tolerance for disclosed materials is about two times greater than for the comparison cordierites. Thermal Shock Parameter (TSP) is comparable to LMC. These materials show potential for current thermal shock applications. However compared to NMC, the disclosed materials show a lower TSP.

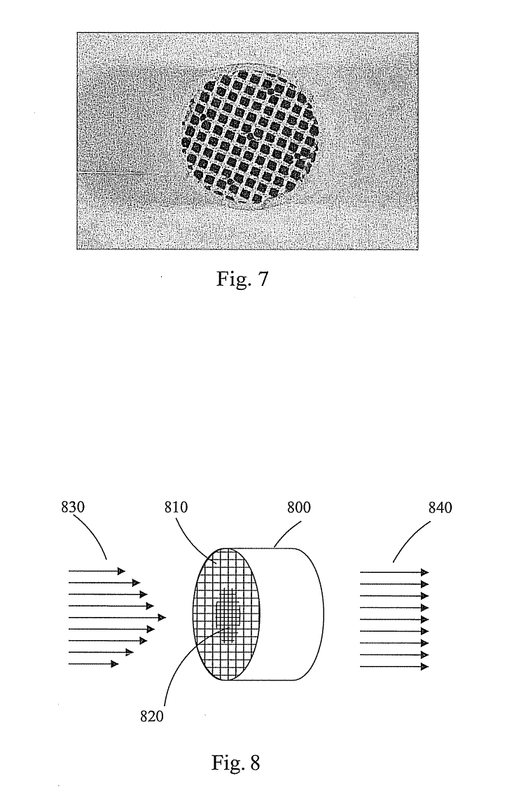

High chemical and mechanical stability in combination with high permeability (porosity) Table 6 shows that mullite bodies had a greater MOR compared to the other materials. For example, mullite at higher porosity showed greater strength than cordierite with lower porosity. Additionally, mullite is refractory with higher thermal and chemical durability. Higher porosity in this material can enable greater throughput. This was demonstrated by using a 1″ diameter filter made by the 3D print process. FIG. 7 shows the structure that was used for this test. Compared to a 1 inch part made by extrusion, the disclosure part showed 63% increase in water flow even though the geometric surface area for the disclosure part was approximately one third.

High surface area As a result of higher porosity, the internal surface area within the structure and lattice web/wall can be increased. This can be exploited for catalyst applications. For example, zeolite made according to the disclosure can be more effectively used on a mass basis. Zeolite ceramics, such as a filter printed with zeolite powders, has been demonstrated using the process.

Low thermal mass. Another consequence of higher porosity is a low thermal mass. This suggests potential use in fast light-off situations, e.g., quicker acting automotive catalytic converters.

Geometries and article shapes. The 3D print process enables the creation of complex shapes and achieving designs that are currently not accessible by other methods. The combination of properties or attributes with a new design can provide new capability and improved performance. Example uses include: manifolds for heat exchangers, fuel cells, micro-reactors, and like articles. Other example uses include creating graded structure as shown in FIG. 8. Here the 3D article (800) can be constructed having a wall (e.g., solid, porous, or skinned), a honeycomb-like interior having macro porosity that can have, for example a porous lattice spacing that has graded or graduated dimension that decrease from larger cells (810) at the periphery to smaller cells (820) near the center which can create a radial profile to counteract peripheral pressure drop (830). This can be used to level or equalize the flow front (840) resulting in superior utilization of catalyst or radial ash distribution in such flow applications.

Table 4 shows mass fractions for each component in prepared articles. Binder amounts are super additions to the inorganic material and sintering aid.

TABLE 4
Aluminosilicate starting materials and products of the process.

| | Principal | | | |
|---|---|---|---|---|
| | Inorganic | | Organic | Dipping |
| | Raw Material | Sintering Aid | Binder | Solution |
| Mullite | Mullite | Bentonite Clay | Fish Gel (FG) | Mullite sol |
| | Grog | (10%) | or Urea | precursor |
| | (90%) | | Formaldehyde | |
| | | | (UF) | |
| Cordierite | Cordierite | Cordierite | Fish Gel or | Cordierite sol |
| (Magnesium | Grog | glass or | Urea | |
| Aluminosilicate) | (85%) | Cordierite | Formaldehyde | |
| | | batch (15%) | | |
| β - Spodumene | Petalite or | — | Fish Gel or | Beta |
| (Lithium | or beta- | | Urea | Spodumene |
| Aluminosilicate) | spodumene | | Formaldehyde | sol precursor |
| | grog | | | |
| Zeolite | Zeolite | — | Fish Gel or | Silica sol |
| (Sodium | powder | | Urea | precursor |
| Aluminosilicate) | | | Formaldehyde | |

TABLE 5
Comparison of body properties prepared by the
disclosed 3D printing and a casting process.

| | | green | fired | fired | linear | fired | fired |
|---|---|---|---|---|---|---|---|
| forming | | density | density | apparent | shrink- | sag* | str** |
| method | impreg | (g/cm³) | (g/cm³) | porosity | age | (mm) | (psi) |
| Casting | 2x | 1.135 | 1.30 | 48% | 4.75% | — | 1435 |
| 3D | 2x | 1.02 | 1.04 | 58% | 3.6% | 0.6 | 1150 |
| Printing | | | | | | | |

*fired sag (mm) is the difference in the length of a bar before and after firing, and can be measured by placing the bar onto a 40 mm span and firing.
**fired str(psi) is the fired material strength in pounds per square inch.

TABLE 6
Properties of aluminosilicate articles prepared by the disclosed 3D printing process.

| | | | Modulus | | | | |
|---|---|---|---|---|---|---|---|
| | Firing | | (from | | | CTE @ | CTE @ |
| | Soak | | MOR | Emod | CTE @ | 1,000° C. | 1,000° C. |
| | Temperature | MOR | test) | (Sonic Res) | 800° C. | (×10⁶) | (×10⁶) |
| Material | (° C.) | psi | psi | psi | (×10⁷) | Heating | Cooling |
| Cordierite @ | 1400 | 804 | 6.55E+05 | | | 1.59 | 1.69 |
| 1400° C. | | | | | | | |
| Cordierite @ | 1410 | 891 | 8.03E+05 | 9.19E+05 | 15.55 | 1.735 | 1.81 |
| 1410° C. | | | | | | | |
| Cordierite @ | 1420 | 1006 | 8.13E+05 | | 14.85 | 1.685 | 1.69 |
| 1420° C. | | | | | | | |
| Cordierite @ | 1430 | 1312 | 1.06E+06 | | 15.55 | 1.73 | 1.77 |
| 1430° C. | | | | | | | |
| High | 1410 | | | | | | |
| Porosity | | | | | | | |
| Cordierite A | | | | | | | |
| w/ Added | | | | | | | |
| Binder | | | | | | | |
| High | 1410 | | | | | | |
| Porosity | | | | | | | |
| Cordierite B | | | | | | | |
| w/ Added | | | | | | | |
| Binder & | | | | | | | |
| 1% Fine | | | | | | | |
| Poreformer | | | | | | | |
| High | 1410 | | | | | | |
| Porosity | | | | | | | |
| Cordierite C | | | | | | | |
| w/ 20% | | | | | | | |
| Poreformer | | | | | | | |
| Cordierite | 1400 | 882 | 6.64E+06 | | 15.3 | 1.69 | 1.77 |
| UF Process | | | | | | | |
| Mullite @ | 1475 | 1013 | 7.99E+05 | 1.19E+06 | 47.65 | 5 | 5.03 |
| 1475° C. | | | | | | | |
| Mullite @ | 1515 | 905 | 9.09E+05 | | 47.8 | 5 | 5.07 |
| 1515° C. | | | | | | | |
| Mullite @ | 1575 | 1474 | 1.39E+06 | 1.98E+06 | 48.2 | 5.08 | 5.1 |
| 1575° C. | | | | | | | |
| Beta | 1320 | 419 | 4.37E+05 | 5.47E+05 | 0.45 | 0.11 | 0.25 |
| Spodumene | | | | | | | |
| @ 1320° C. | | | | | | | |
| Beta | 1350 | 595 | 6.03E+05 | | 1.17 | 0.25 | 0.42 |
| Spodumene | | | | | | | |
| @ 1350° C. | | | | | | | |
| Beta | 1380 | | | | 1.20 | 0.25 | 0.41 |
| Spodumene | | | | | | | |
| @ 1380° C. | | | | | | | |

| | | | D- | | | |
|---|---|---|---|---|---|---|
| | | Median | factor | | Bulk | |
| | Hg | Pore | (d₅₀ − | Apparent | Density | |
| Material | Porosity % | (μm) | d₁₀)/d₅₀ | Porosity % | (g/cc) | Shrinkage % |
| Cordierite @ | | 0 | 0 | 0 | 0 | 0 |
| 1400° C. | | | | | | |
| Cordierite @ | 55.9 | 15.9 | 0.68 | 59.0% | 1.12 | 3.6% |
| 1410° C. | | | | | | |
| Cordierite @ | 55.6 | 17.1 | 0.60 | 59.7% | 1.12 | 4.4% |
| 1420° C. | | | | | | |
| Cordierite @ | 51.3 | 17.1 | 0.46 | 56.2% | 1.26 | 6.1% |
| 1430° C. | | | | | | |
| High | | | | 56.9% | | |
| Porosity | | | | | | |
| Cordierite A | | | | | | |
| w/ Added | | | | | | |
| Binder | | | | | | |
| High | | | | 61.7% | | 4.0% |
| Porosity | | | | | | |
| Cordierite B | | | | | | |
| w/ Added | | | | | | |
| Binder & | | | | | | |
| 1% Fine | | | | | | |
| Poreformer | | | | | | |
| High | | | | 65.3% | | 3.8% |
| Porosity | | | | | | |
| Cordierite C | | | | | | |
| w/ 20% | | | | | | |
| Poreformer | | | | | | |
| Cordierite | 58.3% | 14.52 | 0.58 | | 1.04 | |
| UF Process | | | | | | |
| Mullite @ | 63.5 | 16.3 | 0.74 | 66.9% | 1.12 | 2.2% |
| 1475° C. | | | | | | |
| Mullite @ | 63.3 | 19.7 | 0.76 | 66.4% | 1.13 | 2.8% |
| 1515° C. | | | | | | |
| Mullite @ | 59.7 | 18.6 | 0.70 | 64.6% | 1.22 | 4.7% |
| 1575° C. | | | | | | |
| Beta | 53.2 | 22.3 | 0.84 | 67.6% | 1.12 | 0.9% |
| Spodumene | | | | | | |
| @ 1320° C. | | | | | | |
| Beta | 52.5 | 25.8 | 0.70 | 67.5% | 1.09 | 1.0% |
| Spodumene | | | | | | |
| @ 1350° C. | | | | | | |
| Beta | | | | | | |
| Spodumene | | | | | | |
| @ 1380° C. | | | | | | |

TABLE 7
Properties of cordierite articles prepared by casting.

| | Firing | | Apparent | Bulk | |
|---|---|---|---|---|---|
| | Soak | MOR | Porosity | Density | Shrinkage |
| Material | Temp(° C.) | (psi) | (%) | (g/cc) | (%) |
| Cordierite | 1,400 | 1,435 | 48% | 1.3 | 4.9% |
| (Mold Cast) | | | | | |
| Cordierite | 1,400 | 412 | 64% | 0.9 | 4.6% |
| (Mold Cast) | | | | | |
| w/18% | | | | | |
| Poreformer | | | | | |

TABLE 8
Disclosed materials compared to Low-Microcracked Cordierite (LMC) and Non-Microcracked Cordierite (NMC) for
strain tolerance and calculated thermal shock parameter (TSP).

| | | | | | 3D Freeform | | | |
|---|---|---|---|---|---|---|---|---|
| | (LMC) - | (NMC- | (NMC- | (NMC- | Cordierite w/ UF | 3D Freeform | 3D Freeform at | 3D Freeform at |
| | 50% | A*) 55% | B*) 60% | C*) 65% | at 1,410° C. - | at 1410° C. - | 1420° C. - 55% | 1430° C. - 51% |
| | Porosity | Porosity | Porosity | Porosity | 58% Porosity | 55% Porosity | Porosity | Porosity |
| Axial MOR (psi) | 459 | 1370 | 959 | 563 | 882 | 890.5 | 1006.4 | 1312.1 |
| Axial eMOD* (psi) | 7.61E+05 | 8.60E+05 | 4.25E+05 | 2.84E+05 | 6.64E+05 | 9.19E+05 | 8.13E+05 | 1.06E+06 |
| CTE @ 800° C. | 3.9 | 15.4 | 14.5 | 15 | 15.3 | 15.5 | 14.9 | 15.5 |
| CTE 500° to | 11.2 | 22.5 | 21.5 | 22.2 | 22.9 | 22.9 | 22.7 | 23.1 |
| 1000° C. | | | | | | | | |
| Strain Tolerance | 0.06% | 0.16% | 0.23% | 0.20% | 0.13% | 0.10% | 0.12% | 0.12% |
| @ RT | | | | | | | | |
| TSP (° C.) | 536 | 708 | 1049 | 892 | 580 | 423 | 545 | 533 |

*See G. Merkel, Non-Microcracked Cordierite (NMC), U.S. Pat. Pub. 2009/0137382.

The disclosure has been described with reference to various specific embodiments and techniques. However, it should be understood that many variations and modifications are possible while remaining within the spirit and scope of the disclosure.

What is claimed is:

1. A method for making a porous article, the method comprising:
depositing a powder mixture layer comprising a binder powder, and at least one structural powder, the binder powder comprises a protein, the protein being soluble in water at or below about 25° C.;
contacting the powder mixture layer and an aqueous liquid to selectively activate the binder powder and form a green layer;
repeating the depositing and contacting at least one time; and
de-powdering and then drying of the resulting green body.

2. The method of claim 1, wherein the protein comprises milk protein, peanut protein, wheat protein, egg protein, fish gelatin, ferritin, a protein hydrozylate, or combinations thereof.

3. The method of claim 1, wherein the protein comprises a protein hydrozylate.

4. The method of claim 1, wherein the protein comprises a fish gelatin.

5. A method for a making a porous green body, the method comprising:
depositing a powder mixture layer comprising fish gelatin binder powder, and at least one structural powder;
contacting the powder mixture layer and an aqueous liquid to selectively activate the binder powder and form a green layer; and
depowdering and final drying the resulting green body.

6. The method of claim 5 wherein the fish gelatin binder powder comprises an average particle size of from about 25 microns to about 74 microns in an amount of from about 1 to about 20 weight percent, and the at least one structural powder comprises a mixture of fine structural powder having an average particle size of less than about 15 microns and in an amount of from about 10 to about 80 weight percent, and a less-fine structural powder having an average particle size of about 20 to about 75 microns and in an amount of from about 10 to about 80 weight percent of the total weight percent of the powder mixture.

7. The method of claim 5 wherein the depositing and contacting the powder mixture layer and an aqueous liquid comprises a first depositing of a layer of the powder mixture having a thickness of from about 20 to about 200 micrometers, and a second, selectively activating the fish gelatin binder in the deposited powder mixture with an aqueous spray to form a green body layer.

8. The method of claim 5 wherein contacting the powder mixture layer and an aqueous liquid to selectively activate the binder powder further comprises an intermediate or partial drying after contacting each layer or all layers of the article comprising standing for from about 0.1 min to about 24 hrs at from ambient to 50° C., and the final drying comprising heating the article at about 50 to 100° C. for about 1 to about 10 hrs.

9. The method of claim 5 further comprising a second de-powdering of the finally dried green body.

10. The method of claim 5 wherein contacting the powder mixture layer and an aqueous liquid is accomplished with an ink-jet printer.

11. The method of claim 5 wherein the depositing and contacting is sequentially and repeatedly accomplished from 2 to about 1,000,000 times.

12. The method of claim 5 further comprising firing the resulting green body to obtain a ceramic body having a microporosity of from about 50 to about 85% by void volume.

13. The method of claim 12 wherein the porosity comprises micro-porosity in an amount of from about 40 to about 80% void volume arising from low packing density in the at least one printing of the powder layer, 0 to about 40% void volume arising from an optional fugitive pore former departure if present, and macro-porosity in an amount of from about 1 to about 99% void volume arising from null 3D printing, and a total microporosity of about 40 to about 80% by void volume.

14. A green body article by the method of claim 1.

15. An article by the method of claim 13.

16. A batch composition comprising a powder mixture comprising fish gelatin binder, and at least one structural powder selected from at least one of carbon, sulfur, cordierite, beta-spodumene, zeolite, petalite, mullite, clay, beta-eucryptite, a solid solution of beta-quartz, celsian, anorthite, Sr-feldspar, leucite, pollucite, nepheline, aluminum titanate, alumina, silica, zirconia, soda-lime glass, borosilicate glass, silicon carbide, or mixtures thereof.

17. The composition of claim 16 further comprising water in an amount of from about 0.01 to about 10 weight percent based on the total weight of the composition.

18. A 3D honeycomb ceramic article having an internal geometric surface area from about 100 to about 2,000 square meters per cubic meter and having a substantially uniform fluid flow front therethrough.

19. A 3D ceramic article by the process of claim 12 having a total porosity of about 40 to about 97% by void volume.

20. A porous alumino-silicate ceramic prepared by the process comprising:
forming a green body from at least one alumino-silicate source powder;
impregnating the green body with a sol-gel precursor solution;
drying the impregnated green body to form a sol-gel on at least the interior of the green body;
optionally repeating the impregnation and drying one or more times; and
firing the green body to afford the porous alumino-silicate ceramic.
